(19) United States
(12) Patent Application Publication
(10) Pub. No.: US 2024/0157293 A1
(43) Pub. Date: May 16, 2024

(54) APPARATUS AND METHOD FOR PURIFYING A PROCESS GAS CONTAINING AT LEAST ONE POLLUTANT GAS

(71) Applicant: EBARA Precision Machinery Europe GmbH, Hanau (DE)

(72) Inventors: Christian VENUS, Dresden (DE); Peter Raffael KUMICHEL, Dresden (DE); Philipp ROTHE, Dresden (DE); Sven LEONHARDT, Dresden (DE); Martin SALOMO, Dresden (DE)

(21) Appl. No.: 18/506,176

(22) Filed: Nov. 10, 2023

(30) Foreign Application Priority Data
Nov. 11, 2022 (DE) 10 2022 212 009.4

(51) Int. Cl. B01D 53/76; B01D 53/00; B01D 53/46

(52) U.S. Cl. CPC B01D 53/76; B01D 53/005; B01D 53/46; B01D 2251/102; B01D 2251/11; B01D 2257/553

(57) ABSTRACT

An apparatus for purifying a process gas containing at least one pollutant gas, having a reactor vessel, has a cylindrical region and a tapering region, and into which oxygen or an oxygen-containing gas can be introduced as a reaction gas into at least one gas inlet and can be discharged through at least one gas outlet. The at least one gas inlet introduces a defined volumetric flow of the reaction gas into the reactor vessel tangentially to a circumferential surface of the cylindrical region. The apparatus may have a pollutant gas inlet, which introduces a defined volumetric flow of the process gas containing at least one pollutant gas into the reactor vessel, so that the at least one pollutant gas and the reaction gas are mixed with each other in the direction of the gas outlet and chemically react with each other on their way through the reactor vessel.

### FIELD

The present invention relates to an apparatus and a method for cleaning a process gas containing at least one pollutant gas.

### BACKGROUND

Pyrophoric and/or toxic gases, which among other things also contribute to global warming, are generated in various chemical processes, but because of their harmful properties they often have to be treated at great expense and rendered as harmless as possible. Various solutions are known from the prior art:

DE 20 2005 021 057 U1 discloses a gas pollutant degradation system as a burner-scrubber system for reacting gases, in which the temperature required to (de)react such gases is generated in a combustion chamber. The disadvantages of this are the high acquisition cost and, due to the energy-intensive treatment, also high maintenance costs of such a system.

From EP 1 070 532 A1 a flow separation system with mixing chambers is known, which has an elaborately designed mixing chamber with internal pipes, inlets and channels, which is complicated and thus expensive to manufacture and is only applicable to a relatively limited number of applications. EP 1 129 763 A1 discloses another system in which water is introduced into a gas stream or the gas stream is mixed with preheated air. This system also has a complicated structure, which means that the procedures carried out with such a system are also complicated and require expensive controlling.

### SUMMARY

The present invention is therefore based on the object of proposing a device and a method which avoids the disadvantages mentioned, i.e. with which a pollutant gas can be rendered harmless in an efficient manner.

This object is solved according to the invention by a device and a method according to the independent claims. Advantageous embodiments and further developments are described in the dependent claims.

An apparatus for cleaning or rendering harmless a process gas containing at least one pollutant gas (wherein the process gas itself may also be the pollutant gas), comprises a reactor vessel designed as a centrifugal separator having a cylindrical or hollow cylindrical portion and a tapering portion. Oxygen or an oxygen-containing gas can be introduced into the reactor vessel as reaction gas through at least one gas inlet arranged on the cylindrical region and can be discharged from the reactor vessel through at least one gas outlet arranged on the tapering region. The at least one gas inlet is arranged and configured to introduce a defined volumetric flow of the reaction gas into the reactor vessel tangentially to a circumferential surface of the cylindrical region. A pollutant gas inlet is also arranged at the cylindrical region, which is designed to introduce a defined volume flow of the process gas containing at least one pollutant gas into the reactor vessel, so that the at least one pollutant gas and the reaction gas are mixed with one another in the direction of the gas outlet and react chemically with one another on their way through the reactor vessel. The gas outlet is arranged and formed to discharge process gas not reacted in the chemical reaction and reaction products of the chemical reaction from the reactor vessel.

This device makes it possible to set up a reactor in a simple manner, whereby the defined introduction of the various gases enables a reproducible and detectable chemical reaction. The design as a centrifugal separator (which is also referred to as a cyclone, cyclone separator or vortex separator) not only enables reliable suction of the gases involved in the chemical reaction and their transfer in the direction of the gas outlet, but also ensures a flow-optimized design due to the arrangement of the gas inlet, in which typically an immediate or complete mixing of the gases is achieved and not just a simple dilution of the pollutant gas. In simple terms, the device or a process carried out with it and its use are optimized and a controlled and safe reaction or oxidation is enabled, which protects the environment and surroundings and reduces the costs for this process compared to the prior art. At the same time, an improved product is achieved, i.e. instead of dilution, the actual reaction of the pollutant gas takes place and thus a reduction of the pollutant gas emission is achieved. Thus, it is possible to select and reuse the reaction products with respect to their purity.

For setting the defined volume flow, it can be provided that the apparatus has a device for setting a volume flow, by means of which the defined volume flow of the process gas containing at least one pollutant gas and/or the defined volume flow of the reaction gas can be set before it is introduced into the reactor vessel. Typically, this volume flow is between 300 m³/hr and 2600 m³/hr, preferably between 600 m³/hr and 1300 m³/hr. Alternatively or additionally, the apparatus may include a compressor to introduce the process gas and/or the reaction gas into an interior of the reactor vessel.

A temperature sensor may be provided at the gas outlet or in the gas outlet to sense a temperature of the, typically exothermic, chemical reaction in the reactor vessel. The determined temperature can be transferred to the device for setting a volume flow in order to readjust the defined volume flow accordingly, so that a control or, if necessary, also a regulation of the reaction can take place. Typically, this temperature sensor is located centrally in the gas outlet.

Alternatively or additionally, a flow velocity sensor may be arranged in the gas inlet or at the gas inlet and or in the pollutant gas inlet or at the pollutant gas inlet. The determined flow rate of the respective gas can also be transmitted to the device for setting a volumetric flow rate and used as an open-loop control parameter or a closed-loop control parameter.

In order to carry out oxidation for cleaning, in addition to oxygen, an ambient air mixture in particular can also be used as a reaction gas containing oxygen, which makes the entire process easier to carry out.

To support the chemical reaction, a heating device may be arranged in the reactor vessel or on the reactor vessel. This heating device is preferably designed as an electrical resistance heater and, if necessary, can also be controlled or regulated by the device for setting a volumetric flow.

The reactor vessel itself is typically made of stainless steel, and standardized standard pipes and ISO flanges are usually used for the gas inlet, the gas outlet, and the pollutant gas outlet, respectively, in order to keep the design simple and cost-effective.

The reactor vessel is typically designed closed to the gas inlet, the gas outlet or the pollutant gas outlet, i.e. it is gas-tight or fluid-tight.

The pollutant gas inlet may be located on an end face, i.e., on the circular surface of the cylindrical section, to ensure direct mixing with the tangentially inflowing reaction gas.

The tapering region is typically designed as a conically tapering region. In principle, however, the taper can also be described with a polynomial function and a resulting rotation body.

The gas outlet is usually curved to provide a defined geometry for pure discharge of the gas mixture inside the reactor vessel. Preferably, the gas outlet is curved by 90°.

The pollutant gas inlet is typically located opposite the gas outlet. Preferably, the pollutant gas inlet is configured such that the pollutant gas is introduced into the reactor vessel rotationally symmetrically with respect to a longitudinal axis of the gas outlet, typically with respect to a central axis of the gas outlet.

Removably attachable to the gas outlet, i.e., removable and/or attachable, may be a filter element to the filter element, a scrubber and/or a collection container for reaction products to safely collect and remove the reaction products.

In a particularly advantageous manner, silanes and/or diboranes can be treated as pollutant gases with the apparatus described.

A typical residence time of the pollutant gas in the reactor vessel is between 0.3 seconds and 5.0 seconds, with 0.7 seconds to 2.0 seconds as a preferred residence time. Typical process temperatures can range from 20° C. to 300° C., preferably 40° C. to 200° C.

In a process for purifying a process gas containing at least one pollutant gas, a defined volumetric flow of oxygen or of an oxygen-containing gas is introduced as reaction gas tangentially to a circumferential surface of the cylindrical region into the reactor vessel formed as centrifugal separator having a cylindrical region and a tapering region via at least one gas inlet arranged on the cylindrical region. A defined volumetric flow of the process gas containing the pollutant gas is introduced into the reactor vessel via a pollutant gas inlet arranged on the cylindrical region, the pollutant gas and the process gas being mixed with one another, reacting chemically with one another on their way through the reactor vessel, and process gas not reacted during the chemical reaction and reaction products of the chemical reaction being discharged from the reactor vessel through the gas outlet.

The described method can be carried out with the described apparatus, i.e. the described apparatus is configured to execute the described method.

### DESCRIPTION OF THE FIGURES

Examples of embodiments of the invention are shown in the drawings and are explained below with reference to FIGS. 1 to 4. Shown are:

FIG. 1 a schematic side view of an apparatus for purifying a process gas containing at least one pollutant gas;

FIG. 2 a view of the apparatus, rotated by 90° compared to FIG. 1;

FIG. 3 a schematic flow path through the device according to FIGS. 1 and 2; and

FIG. 4 a schematic flow path in perspective view.

### DETAILED DESCRIPTION

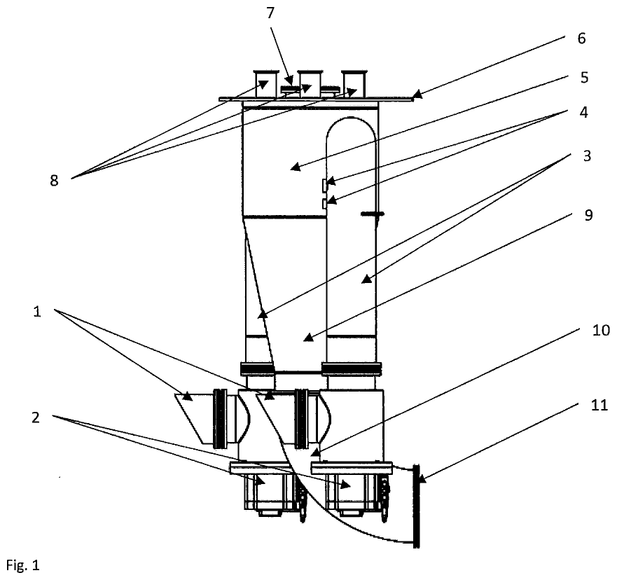

FIG. 1 shows a schematic side view of an example of a device for cleaning a process gas containing at least one pollutant gas. Ambient air as reaction gas can flow into the device via one or more intake or inlet ports 1. From inlet ports 1, the reaction gas flows through corner valves 2, through one or more inlet tubes 3, and past metering ports through an elbow to ambient gas mixture ports 12. The inlet ports 1, the corner valves 2 and the inlet tubes 3 together with the ambient gas mixture connections 12 thus form the gas inlets into the reactor vessel, which has a hollow cylindrical region 5 and a conically tapering region 9. Metering ports for various measuring devices can also be arranged on the inlet tubes 3.

The ambient gas mixture connections 12 are arranged tangentially to the here straight, i.e. cylindrical, region 5 of the reactor vessel designed as a cyclone or centrifugal separator. Above the cylindrical region 5 of the reactor vessel, the reactor vessel is sealed in a gas-tight manner by a reactor plate 6 or a reactor lid, on which several pollutant gas inlets 8 are arranged. In the embodiment shown in FIG. 1, three of these pollutant gas inlets 8 can be seen; in this view, the fourth pollutant gas inlet 8 is concealed by the centrally located one. An inspection opening with a cover 7 can be seen behind the centrally arranged pollutant gas inlet 8, i.e. the pollutant gas inlets 8 are arranged concentrically around the cover 7 on a flow-optimized circle. Thus, the pollutant gas inlets 8 are rotationally symmetrical about a longitudinal axis or center axis of the transition of the tapered region 9 to the 90° elbow 10. In further embodiment examples, measuring instruments or scrapers or scrapers referred to as “scrapers” can also be introduced into an interior of the reactor vessel for cleaning through the opening closed by the lid 7, or the opening can be used for inspection purposes. A conically tapering region 9 of the reactor vessel adjoins the cylindrical region 5 at the bottom. This cone of the cyclone is followed by the 90° elbow 10, which forms a transition to the connection to the exhaust 11 and thus the gas outlet. The ambient gas mixture ports 12 are arranged tangentially at a distance from the reactor plate 6. After a short, straight pipe, these connections in the example shown continue downward in a 90° elbow, perpendicular to the substrate, and end at the angle valves 2 with spring return, whose outlet again runs parallel to the substrate. An obliquely cut-off, straight circular cylinder is arranged at this outlet, which serves as an intake or inlet port 1 and enlarges an inflow cross section. This facilitates an inflow into the gas inlet. Through-hole threads can be arranged in the vertical tubes to accommodate, for example, measuring devices such as a Pitot tube or other volume or velocity sensors. The size of these threads is usually selected depending on the plant, but they are standardized to be screwed airtight with a blind cover.

In the embodiment shown in FIG. 1, the device is arranged in an upright position, i.e. the reactor vessel is oriented in such a way that a vertical axis is perpendicular to the substrate. The reactor vessel itself has at its upper end, which is considered to be further away from the substrate, the cylindrical portion 5, which merges in the direction of the substrate into the frustoconical, tapering region 9. The apparatus itself terminates at the exhaust 11 in an outer frame structure (not shown for the sake of clarity) that supports the apparatus. In the embodiment shown, the pollutant gas inlets 8 are arranged vertically on the reactor plate 6, but in further embodiments they can also open into the reactor plate 6 at other angles or also have an arcuate design. As a rule, the pollutant gas inlets 8 are designed as KF flanges in order to be able to close them easily for transport and to provide a standardized connection.

The device shown in FIG. 1 enables a cost-effective and stable cleaning or reaction of pollutant gases. Chemical compounds such as silane or diborane are highly reactive on their own, but must be appropriately supported for the compound to break down from the gaseous state into dust or particles that can then be deposited or ingested downstream. With the presented device and its optimized flow, which will be explained in more detail in the following, a control of this process as well as its monitoring can be achieved, which ultimately result in improved purification results compared to the prior art.

The device for oxidation of a pollutant gas in a reactor that can be closed off from its environment enables a flow-optimized inflow of the ambient gas mixture, typically air. Due to the inflow in the cylindrical region 5 tangential to the shell surface and with the aid of the cyclone principle, a comparatively long residence time in the reactor vessel and thus a thorough reaction is made possible without a complicated structure. For this purpose, the reaction gas flows from the inner wall of the reactor vessel in a kind of vortex of defined volume through a continuous gas flow in the direction of the gas outlet or exhaust 11. The reactor chamber itself tapers conically in the direction of flow toward exhaust 11. Due to the fact that the pollutant gas inlet 8 is oriented on the front side in such a way that the vertical axis or longitudinal axis of the entire device is perpendicular to the ground and thus parallel to the acting gravitational force, the process gas 22 containing the pollutant gas also flows into the reactor vessel in the direction of gravity, is sucked in by the cyclone's vortex and consequently flows in a kind of helical movement or spiral motion in the direction of the gas outlet. It is in constant contact with the ambient gas mixture and reacts with it without losing heat via the reactor wall in an exothermic reaction or falling below a necessary minimum concentration due to excessive dilution. Ideally, the pollutant gas reacts completely inside the reactor vessel until shortly before exhaust 11. By regulating and adjusting the volume flow rates, which can be done by valve control of valves at the gas inlet and the pollutant gas inlet 8 by a device (not shown for overview reasons) for adjusting a volumetric flow rate, for example a computer, this exothermic reaction is ideally controlled. For this purpose, a temperature sensor 13 can also be arranged centrally in the exhaust flow, which continuously measures the temperature and transmits it as a control or regulating parameter to this device for setting a volumetric flow. In addition, in the embodiment example shown in FIG. 1, it can also be provided that the flow velocity or the volumetric flow in at least one inlet pipe is measured and also transmitted to said device as a control or regulating parameter. Preferably, this measurement is made via a Pitot tube or a pitot head in the direction of flow.

In the embodiment shown in FIG. 1, the inlet of the ambient gas mixture is designed as a standardized pipe, preferably the reactor vessel or reaction vessel and all connections are made of stainless steel and can be connected to the pipe system via KF flanges (small flanges) or ISO flanges (International Organization for Standardization) without being limited to them. In further embodiments, a compressor may also be included by the device to selectively allow the ambient gas mixture or process gas to flow in.

In another embodiment, the reactor plate 6 has at least two ports, one of which is the pollutant gas inlet 8 and the other of which is for introducing a heating element that has a surface reaction of pollutant gases having a reaction temperature above ambient temperature, in particular room temperature of 20° C. This starts a presetting or control of the exothermic reaction at this surface and if the temperature inside the reactor vessel, i.e. the centrifugal separator or cyclone, is sufficiently high, the heating element can be deactivated and the reaction is monitored via the temperature sensor 13 in the exhaust 11 and/or a further temperature detector arranged in the interior of the reactor vessel. The gas outlet is arranged opposite the reactor plate 6, which can also be referred to as the reactor lid, at the point of the tapering region 9 where it has the smallest diameter.

Thus, in a corresponding process for the oxidation of pollutant gases such as silane, SiH₄, or diborane, B₂H₆, the reaction gas first flows into the reactor vessel via the corresponding inlets, and a cyclone screw movement is formed in the reactor vessel, extending from the inlet to the interior of the reactor vessel to the gas outlet. The cyclone screw movement is accelerated, in particular also by the tapered part 9, in the direction of the gas outlet 11. Ambient air is drawn in as process gas through the gas inlet, for example by a fan. Preferably by entrainment or suction by this screw movement, the pollutant gas flows in via the pollutant gas inlet 8, which is positioned, for example, on an inner side of the cycle screw movement. On this inner side, the pollutant gas also performs a screwing motion equal to that of the reaction gas, as a result of which a contact zone is formed in the reactor vessel, in which the pollutant gas and the reaction gas 21 react as reactants before mixing below the minimum concentration occurs, in the case of silane, for example, less than 2 percent by volume of the gas mixture (in this case, a minimum concentration of the pollutant gas is maintained).

Mixing the reaction partners starts a (chain) reaction, which over the distance of the cyclone screw movement leads to the pollutant gas completely reacting off, so that after the reaction the two reaction partners have become a gas stream consisting of the reaction gas with a charge, preferably a powder-like or dust-like substance. Here, the gas mixture is accelerated, especially after entering the cone. This gas flow can be collected, separated, filtered or washed out, for which purpose a collecting container and/or a corresponding filter element or a scrubber can be fitted to the exhaust 11 and/or in the exhaust 11. For example, reacted reaction products can be filtered as suspended solids or washed out by passing them through the scrubber. Preferably, an ultrapure substance is filtered and blown out into the collection container for recycling and further processing. If the cyclone movement that forms is stable, which can be achieved, for example, by means of a time constant and/or by evaluating measured variables such as differential pressure, volumetric flow or flow velocity, the inflow is made possible by drawing in the process gas via the pollutant gas inlet 8. The process gas together with the pollutant gas, for example silane as a residual charge from gas cylinders, can also still be limited by mass flow controllers if necessary. Typically, however, upon entering the contact zone, the contaminant gas should have a minimum concentration that, depending on the contaminant gas, corresponds to a critical amount for an independent chain reaction. During the reaction, heat is usually released, which in turn supports the reaction taking place and thus promotes complete reaction. This is made possible by the minimum concentration and residence time in the reactor vessel, but also by the lack of dilution of the reactants, which are only mixed in the contact zone inside the reactor vessel. After the reaction, the two reactants have become a gas stream consisting of air with a loading of silica, which can be separated by the filter unit if required. The filter unit can subsequently blow off this load into a connected collecting container, so that a clean substance is collected and a filter of the filter unit can be loaded several times, as well as the air can be released into the environment without pollutants.

By means of a heating element or a heat source, it can be provided to start the described (chain) reaction when mixing the reactants and, when the reaction is stabilized (which can be the case, for example, after a predetermined time or by detecting process parameters such as the temperature of the gas stream and evaluating these process parameters, the heating element is switched off). For this purpose, the heating element may be positioned in the contact zone or positioned in the immediate vicinity of the pollutant gas inlet, i.e., positioned close to the pollutant gas inlet 8 (typically no more than one diameter of the respective pollutant gas inlet 8 from an edge of the pollutant gas inlet 8), or in the pollutant gas inlet 8 itself. In the case of diborane, this additional heating device is typically still used to start the reaction, since diborane itself does not react independently with oxygen. Even the reaction starts, the heating device can also be switched off. Even though silane and diborane are mentioned as examples, the device and the process can of course also be used for other pollutant gases.

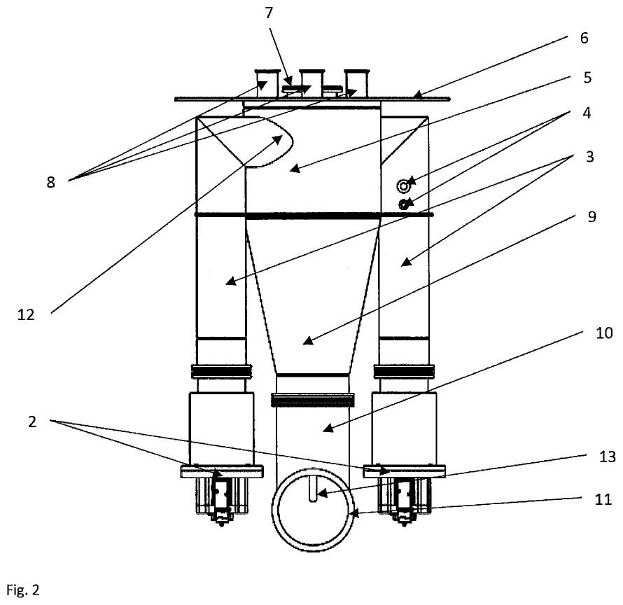

FIG. 2 shows a schematic side view, but now rotated 90° from the view shown in FIG. 1, of the device from the rear without supporting structures. Recurring features are marked with identical reference signs in this figure as well as in the following figures. In particular, the temperature sensor 13 located centrally in the exhaust stream can now be seen more clearly. Thus, as before, the device comprises a cyclone or centrifugal separator with at least two inlets for one reactant each, which react to less harmful or reusable substances during the residence time in the reactor and thus no longer endanger the environment. In addition, the process can be closed off from the environment by safety devices in the event of an accident and is reproducible, controllable and monitorable. At least one spring-returned valve, safety valve, limit switch or generally a valve that is closed when not actuated can be provided as a safety device, or typically several of the above-mentioned safety devices are used, whereby different types can also be used in combination with each other.

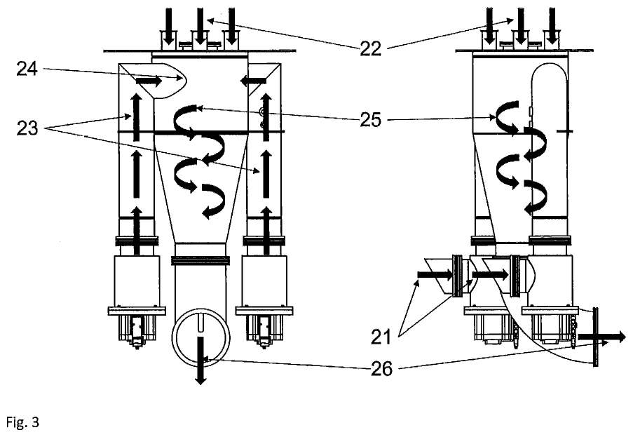

FIG. 3 shows a schematic view of the flow path (in the left part of the figure in a view corresponding to FIG. 1, in the right part of the figure in a view corresponding to FIG. 2). The reaction gas 21, for example an ambient gas mixture, enters the reactor vessel via the intake or inlet ports 1. An inflow 23 is guided in the inlet tubes 3 to the inlet 24 in the reactor vessel, where a cyclone screw movement 25 is formed, drawing in the pollutant gas via the pollutant gas inlets 8. The gas stream flows over the 90° elbow 10 as an exhaust stream 26 into the exhaust 11.

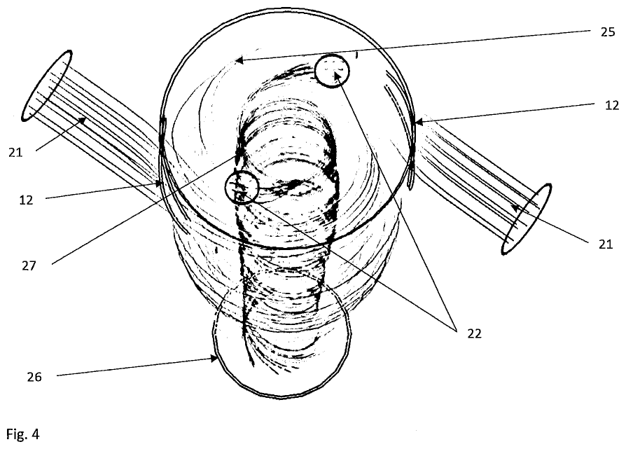

As shown in a schematic perspective view in FIG. 4, the reaction gas 21 enters the reactor vessel tangentially through the ambient gas mixture ports 12. The cyclone screw movement 25 then forms inside, flowing downward in a helical or constant rotation until it reaches the outlet, the 90° elbow 10 and the exhaust 11, as an exhaust gas stream 26. The cyclone screw movement 25 or cyclone flow draws the pollutant gas or process gas 22 in through the pollutant gas inlets 8 and the contact zone 27 is formed between the two. In FIG. 4, the denser lines decrease in the direction of the exhaust gas flow, indicating the minimum concentration decrease, i.e., the reacting off.

Only features of the various embodiments disclosed in the embodiment examples may be combined and claimed individually.

1-10. (canceled)

11. An apparatus for purifying a process gas containing at least one pollutant gas, comprising:
a reactor vessel which is designed as a centrifugal separator and which has a cylindrical region and a tapering region and into which oxygen or an oxygen-containing gas can be introduced as a reaction gas into at least one gas inlet arranged on the cylindrical region and can be discharged through at least one gas outlet arranged on the tapering region, wherein
the at least one gas inlet is arranged and formed to introduce a defined volumetric flow of the reaction gas into the reactor vessel tangentially to a circumferential surface of the cylindrical region, and
a pollutant gas inlet which is arranged on the cylindrical region and is designed to introduce a defined volumetric flow of the process gas containing at least one pollutant gas into the reactor vessel, so that the at least one pollutant gas and the reaction gas are mixed with each other in the direction of the gas outlet and chemically react with each other on their way through the reactor vessel, and
the gas outlet is arranged and designed to discharge process gas not reacted in the chemical reaction and reaction products of the chemical reaction from the reactor vessel.

12. The apparatus according to claim 11, wherein the defined volumetric flow of the process gas containing at least one pollutant gas and/or the defined volumetric flow of the reaction gas can be set by a device for setting a volumetric flow before it is introduced into the reactor vessel.

13. The apparatus according to claim 11, wherein a temperature sensor is/are arranged on or in the gas outlet and/or a flow velocity sensor is/are arranged in or on the at least gas inlet or the pollutant gas inlet.

14. The apparatus according to claim 11, wherein a heating device is arranged in or on the reactor vessel for supporting the chemical reaction.

15. The apparatus according to claim 11, wherein the pollutant gas inlet is arranged at an end face of the cylindrical region of the reactor vessel.

16. The apparatus according to claim 11, wherein the tapering region of the reactor vessel is formed as a conically tapering region.

17. The apparatus according to claim 11, wherein the gas outlet is curved in an arcuate manner by 90°.

18. The apparatus according to claim 11, wherein the pollutant gas inlet is arranged opposite the gas outlet and is formed to introduce the pollutant gas into the reactor vessel rotationally symmetrically with respect to a longitudinal axis of the gas outlet.

19. The apparatus according to claim 11, wherein a filter element, a scrubber and/or a collecting container for reaction products is removably attachable to the gas outlet.

20. A method for purifying a process gas containing at least one pollutant gas, comprising:
a defined volumetric flow of oxygen or of an oxygen-containing gas as reaction gas is introduced tangentially to a circumferential surface of the cylindrical region into the reactor vessel via at least one gas inlet arranged on the cylindrical region, which reactor vessel is designed as a centrifugal separator and has a cylindrical region and a tapering region, and
a defined volumetric flow of the process gas containing the pollutant gas is introduced into the reactor vessel via a pollutant gas inlet arranged on the cylindrical region, wherein
the pollutant gas and the reaction gas are mixed with each other, chemically react with each other on the way through the reactor vessel, and process gas not reacted in the chemical reaction and reaction products of the chemical reaction are discharged from the reactor vessel through the gas outlet.
